(19) United States
(12) Patent Application Publication
(10) Pub. No.: US 2006/0277602 A1
(43) Pub. Date: Dec. 7, 2006

(54) Communication method, communication system, program and recording medium

(75) Inventor: Yasuhiro Mizukoshi, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/446,375

(22) Filed: Jun. 5, 2006

(30) Foreign Application Priority Data
Jun. 7, 2005 (JP) 2005-166549

(51) Int. Cl. G06F 15/16

(52) U.S. Cl. 726/11

(57) ABSTRACT

By conducting cryptographic communication after establishing a session to monitor the cryptographic communication between a server and a firewall, it is possible that the firewall monitors and controls the contents of the communication without changing an existing cryptographic communication protocol. There are hence provided a communication method, a communication system, a program, and a recording medium in which without changing an existing cryptographic communication protocol, the firewall can monitor and control the communication contents.

### BACKGROUND OF THE INVENTION

1. Field of the Invention

The present invention relates to a communication method, a communication system, a program, and a recording medium.

2. Description of the Conventional Art

FIG. 1 is a sequence diagram to explain a communication method of the conventional art.

The method of FIG. 1 is a communication method for cryptographic communication to communicate encrypted data or information between a client and a server via existing firewall.

According to the conventional communication method, in response to a request from client B, Transmission Control Protocol (TCP) connection is set up between client B and FireWall (FW). Client B sends a connection request to firewall FW to establish connection between firewall FW and external server A. To set up connection to external server A, firewall FW sends a Synchronizing (SYNC) packet to external server A. On receiving the packet, external server A sends a reply including a SYN+ACK (Acknowledgement) packet to firewall FW. To complete the TCP connection, firewall FW transfers an ACK packet to external server A. Firewall FW notifies client B of completion of the connection to external server A. Thereafter, the cryptographic communication starts between external server A and client B. Reference is to be made to, for example, Japanese Patent Application Laid-Open No. 2002-141953, 2002-271418, and 2004-192044.

According to the conventional technique of the cryptographic communication between a client and a server via an existing firewall, the firewall has only a function to relay data. Therefore, the firewall cannot recognize the contents of communication, which leads to fear of information leakage. Also, a method in which the firewall conducts operation similar to that of the server to interpret the contents of data to be relayed is attended with a problem that the current certificate system does not work.

### SUMMARY OF THE INVENTION

It is therefore an object of the present invention, which has been devised to remove the problems above, to provide a communication method, a communication system, program, and a recording medium in which without changing an existing cryptographic communication protocol, a firewall can monitor and control the contents of communication.

To remove the problems, there is provided in accordance with a first aspect of the present invention a communication method of conducting cryptographic communication between a client and a server via a firewall. The method includes the step of establishing a session to monitor the cryptographic communication between the server and the firewall and conducting thereafter the cryptographic communication.

In accordance with the first aspect of the present invention, by conducting thereafter the cryptographic communication after establishing a session to monitor the cryptographic communication between the server and the firewall, it is possible for the firewall to monitor and to control the contents of the communication without altering the existing cryptographic communication protocol.

In accordance with a second aspect of the present invention, there is provided a communication method of conducting cryptographic communication between a client and a server via a firewall. The method includes the steps of allowing by the server only the firewall to intercept contents of the communication, notifying by the firewall a communication condition to the server, and conducting thereafter the cryptographic communication.

In accordance with the second aspect of the present invention, the server allows only the firewall to intercept contents of the communication, the firewall notifies a communication condition to the server, and the cryptographic communication is conducted thereafter. Therefore, the firewall can monitor and control the contents of the communication without altering the existing cryptographic communication protocol.

In accordance with a third aspect of the present invention, there is provided a communication method of conducting cryptographic communication between a client and a server via a firewall. The method includes the steps of establishing TCP connection between the client and the firewall, conducting the cryptographic communication between the client and the server, and exchanging monitor information between the firewall and the server.

In accordance with the third aspect of the present invention, TCP connection is established between the client and the firewall, the cryptographic communication is conducted between the client and the server, and the firewall and the server exchange monitor information. This consequently makes it possible for the firewall to monitor and to control the contents of the communication without changing the existing cryptographic communication protocol.

In accordance with a fourth aspect of the present invention, there is provided a communication method of conducting cryptographic communication between a client and a server via a firewall. The method includes the steps of executing TCP connection processing between the client and the firewall in response to a request from the client, transmitting by the client a connection request to the firewall, preparing by the firewall a port number N for a monitoring operation before TCP connection is established between the server and the firewall, notifying by the firewall the port number N to the server using a synchronizing (SYN) packet option at connection between the server and the firewall, sending by the server to the firewall in response to reception of notification of the port number a reply including the port number N using an (SYN+ACK) option, transmitting by the firewall an acknowledgement (ACK) packet as completion of the TCP connection processing to the server, executing by the server the TCP connection processing for the port number N notified from the firewall, notifying the client, by the firewall, of completion of connection to the server; starting the cryptographic communication between the server and the client, and exchanging by the firewall monitor information with the server using the port for the monitoring operation.

In accordance with the fourth aspect of the present invention, after the firewall notifies the client of completion of connection to the server, the cryptographic communication starts between the server and the client, and the firewall exchanges monitor information with the server using the port for the monitoring operation. Therefore, the firewall can monitor and control the contents of the communication without altering the existing cryptographic communication protocol.

In accordance with a fifth aspect of the present invention, in the communication method of the fourth aspect, the firewall sends to the server a request for a filter condition to restrict a type and contents of data exchanged between the server and the client by the cryptographic communication.

In accordance with the fifth aspect of the present invention, the firewall sends to the server a request for a filter condition to restrict a type and contents of data exchanged between the server and the client by the cryptographic communication. Consequently, this makes it possible for the firewall to monitor and to control the contents of the communication without changing the existing cryptographic communication protocol.

In accordance with a sixth aspect of the present invention, in the communication method of the fourth aspect, the firewall sends a request to the server to send therefrom entire communication data exchanged between the server and the client by the cryptographic communication.

In accordance with the sixth aspect of the present invention, since the firewall sends a request to the server to send therefrom entire communication data exchanged between the server and the client by the cryptographic communication, it is possible for the firewall to monitor and to control the contents of the communication without changing the existing cryptographic communication protocol.

In accordance with a seventh aspect of the present invention, there is provided a communication system including a client, a server, and a firewall for conducting cryptographic communication between the client and the server via the firewall, wherein after establishing a session to monitor the cryptographic communication between the server and the firewall, the cryptographic communication is conducted.

In accordance with the seventh aspect of the present invention, since the cryptographic communication is conducted after establishing a session to monitor the cryptographic communication between the server and the firewall, it is possible for the firewall to monitor and to control the contents of the communication without changing the existing cryptographic communication protocol.

In accordance with an eighth aspect of the present invention, there is provided a communication system including a client, a server, and a firewall for conducting cryptographic communication between the client and the server via the firewall, wherein the server allows only the firewall to intercept contents of the communication, the firewall notifies a communication condition to the server, and the cryptographic communication is conducted thereafter.

In accordance with the eighth aspect of the present invention, the server allows only the firewall to intercept contents of the communication, the firewall notifies a communication condition to the server, and the cryptographic communication is conducted thereafter. As a result, the firewall can monitor and control the contents of the communication without altering the existing cryptographic communication protocol.

In accordance with a ninth aspect of the present invention, there is provided a communication system including a client, a server, and a firewall for conducting cryptographic communication between the client and the server via the firewall, wherein the client and the firewall establish TCP connection therebetween, the client and the server conduct the cryptographic communication therebetween, and the firewall and the server exchange monitor information therebetween.

In accordance with the ninth aspect of the present invention, the client and the firewall establish TCP connection therebetween, the client and the server conduct the cryptographic communication therebetween, and the firewall and the server exchange monitor information therebetween. It is consequently possible for the firewall to monitor and to control the contents of the communication without changing the existing cryptographic communication protocol.

In accordance with a tenth aspect of the present invention, there is provided a communication system including a client, a server, and a firewall for conducting cryptographic communication between the client and the server via the firewall. The client issues a request for TCP connection processing between the client and the firewall and transmits a connection request to the firewall, the firewall prepares a port number N for a monitoring operation before TCP connection is established between the server and the firewall and notifies the port number N to the server using an SYN packet option at connection between the server and the firewall, the server sends to the firewall in response to reception of notification of the port number a reply including the port number N using an (SYN+ACK) option, the firewall transmits an ACK packet as completion of the TCP connection processing to the server, the server executes the TCP connection processing for the port number N notified from the firewall, the firewall notifies the client of completion of connection to the server, and the firewall exchanges, when the server and the client start the cryptographic communication therebetween, monitor information with the server using the port for the monitoring operation.

In accordance with the tenth aspect, after the firewall notifies the client of completion of connection to the server, the server and the client start the cryptographic communication therebetween and the firewall exchanges monitor information with the server using the port for the monitoring operation. Resultantly, the firewall can monitor and control the contents of the communication without altering the existing cryptographic communication protocol.

In accordance with an 11th aspect of the present invention, in the communication system of the tenth aspect, the firewall sends to the server a request for a filter condition to restrict a type and contents of data communicated by the cryptographic communication between the server and the client.

In accordance with the 11th aspect, since the firewall sends to the server a request for a filter condition to restrict a type and contents of data exchanged between the server and the client by the cryptographic communication, the firewall is able to monitor and to control the contents of the communication without changing the existing cryptographic communication protocol.

In accordance with a 12th aspect of the present invention, in the communication system of the 11th aspect, the firewall sends a request to the server to send therefrom entire communication data exchanged between the server and the client by the cryptographic communication.

In accordance with the 12th aspect, the firewall sends a request to the server to send therefrom entire communication data exchanged between the server and the client by the cryptographic communication, and hence the firewall can monitor and control the contents of the communication without altering the existing cryptographic communication protocol.

In accordance with a 13th aspect of the present invention, there is provided a program product for making a substantial computer of the server achieve control of cryptographic communication between a client and a server via a firewall. The program product makes the computer execute processing to conduct the cryptographic communication after establishing a session to monitor the cryptographic communication between the server and the firewall.

In accordance with the 13th aspect of the present invention, since the program product makes the computer execute processing to conduct the cryptographic communication after establishing a session to monitor the cryptographic communication between the server and the firewall, it is possible for the firewall to monitor and to control the contents of the communication without changing the existing cryptographic communication protocol.

In accordance with a 14th aspect of the present invention, there is provided a program product for making a substantial computer of the server achieve control of cryptographic communication between a client and a server via a firewall. The program product makes the computer execute processing in which the server allows only the firewall to intercept contents of the communication, the firewall notifies a communication condition to the server, and the cryptographic communication is conducted thereafter.

In accordance with the 14th aspect of the present invention, the program product makes the computer execute processing in which the server allows only the firewall to intercept contents of the communication, the firewall notifies a communication condition to the server, and the cryptographic communication is conducted thereafter. This makes it possible that the firewall monitors and controls the contents of the communication without changing the existing cryptographic communication protocol.

In accordance with a 15th aspect of the present invention, there is provided a program product for making a substantial computer of the server achieve control of cryptographic communication between a client and a server via a firewall. The program product makes the computer execute processing in which the client and the firewall establish TCP connection therebetween, the client and the server conduct the cryptographic communication therebetween, and the firewall and the server exchange monitor information therebetween.

In accordance with the 15th aspect of the present invention, The program product makes the computer execute processing in which the client and the firewall establish TCP connection therebetween, the client and the server conduct the cryptographic communication therebetween, and the firewall and the server exchange monitor information therebetween. Therefore, the firewall is able to monitor and to control the contents of the communication without altering the existing cryptographic communication protocol.

In accordance with a 16th aspect of the present invention, there is provided a program product for making a substantial computer of the server achieve control of cryptographic communication between a client and a server via a firewall. The program product makes the computer execute processing in which TCP connection processing is executed between the client and the firewall in response to a request from the client, the client transmits a connection request to the firewall, the firewall prepares a port number N for a monitoring operation before TCP connection is established between the server, the firewall notifies the port number N to the server using an SYN packet option at connection between the server and the firewall, the server sends to the firewall in response to reception of notification of the port number a reply including the port number N using an (SYN+ACK) option, the firewall transmits an ACK packet as completion of the TCP connection processing to the server, the server executes the TCP connection processing for the port number N notified from the firewall, the firewall notifies the client of completion of connection to the server, the server and the client start the cryptographic communication therebetween, and the firewall exchanges monitor information with the server using the port for the monitoring operation.

In accordance with the 16th aspect of the present invention, the server and the client start the cryptographic communication therebetween after the firewall notifies the client of completion of connection to the server, and the firewall exchanges monitor information with the server using the port for the monitoring operation. This makes it possible that the firewall monitors and controls the contents of the communication without changing the existing cryptographic communication protocol.

In accordance with a 17th aspect of the present invention, in the program produce of the 16th aspect, the program product makes the computer execute processing in which the firewall sends to the server a request for a filter condition to restrict a type and contents of data exchanged between the server and the client by the cryptographic communication.

In accordance with the 17th aspect of the present invention, the program product makes the computer execute processing in which the firewall sends to the server a request for a filter condition to restrict a type and contents of data exchanged between the server and the client by the cryptographic communication. Resultantly, the firewall is able to monitor and to control the contents of the communication without altering the existing cryptographic communication protocol.

In accordance with an 18th aspect of the present invention, in the program produce of the 16th aspect, the program product makes the computer execute processing in which the firewall sends a request to the server to send therefrom entire communication data exchanged between the server and the client by the cryptographic communication.

In accordance with the 18th aspect of the present invention, since the program product makes the computer execute processing in which the firewall sends a request to the server to send therefrom entire communication data communicated by the cryptographic communication between the server and the client, the firewall can monitor and control the contents of the communication without altering the existing cryptographic communication protocol.

In accordance with a 19th aspect of the present invention, there is provided a recording medium having recorded a program product for making a substantial computer of the server achieve control of cryptographic communication between a client and a server via a firewall. The program product makes the computer execute processing to conduct the cryptographic communication after establishing a session to monitor the cryptographic communication between the server and the firewall.

In accordance with the 19th aspect of the present invention, the program product recorded in the recording medium makes the computer execute processing to conduct the cryptographic communication after establishing a session to monitor the cryptographic communication between the server and the firewall. Consequently, the firewall can monitor and control the contents of the communication without changing the existing cryptographic communication protocol.

In accordance with a 20th aspect of the present invention, there is provided a recording medium having recorded a program product for making a substantial computer of the server achieve control of cryptographic communication between a client and a server via a firewall. The program product makes the computer execute processing in which the server allows only the firewall to intercept contents of the communication, the firewall notifies a communication condition to the server, and the cryptographic communication is conducted thereafter.

In accordance with the 20th aspect of the present invention, the program product recorded in the recording medium makes the computer execute processing in which the server allows only the firewall to intercept contents of the communication, the firewall notifies a communication condition to the server, and the cryptographic communication is conducted thereafter. As a result, the firewall can monitor and control the contents of the communication without altering the existing cryptographic communication protocol.

In accordance with a 21st aspect of the present invention, there is provided a recording medium having recorded a program product for making a substantial computer of the server achieve control of cryptographic communication between a client and a server via a firewall. The program product makes the computer execute processing in which the client and the firewall establish TCP connection therebetween, the client and the server conduct the cryptographic communication therebetween, and the firewall and the server exchange monitor information therebetween.

In accordance with the 21st aspect of the present invention, the program product recorded in the recording medium makes the computer execute processing in which the client and the firewall establish TCP connection therebetween, the client and the server conduct the cryptographic communication therebetween, and the firewall and the server exchange monitor information therebetween. The firewall can monitor and control the contents of the communication without altering the existing cryptographic communication protocol.

In accordance with a 22nd aspect of the present invention, there is provided a recording medium having recorded a program product for making a substantial computer of the server achieve control of cryptographic communication between a client and a server via a firewall. The program product makes the computer execute processing in which TCP connection processing is executed between the client and the firewall in response to a request from the client, the client transmits a connection request to the firewall, the firewall prepares a port number N for a monitoring operation before TCP connection is established between the server, the firewall notifies the port number N to the server using an SYN packet option at connection between the server and the firewall, the server sends to the firewall in response to reception of notification of the port number a reply including the port number N using an (SYN+ACK) option, the firewall transmits an ACK packet as completion of the TCP connection processing to the server, the server executes the TCP connection processing for the port number N notified from the firewall, the firewall notifies the client of completion of connection to the server, the server and the client start the cryptographic communication therebetween, and the firewall exchanges monitor information with the server using the port for the monitoring operation.

In accordance with the 22nd aspect of the present invention, the firewall notifies the client of completion of connection to the server, the server and the client start the cryptographic communication therebetween, and the firewall exchanges monitor information with the server using the port for the monitoring operation. Therefore, the firewall can monitor and control the contents of the communication without changing the existing cryptographic communication protocol.

In accordance with a 23rd aspect of the present invention, in the program product stored in the recording medium of the 22nd aspect, the firewall sends to the server a request for a filter condition to restrict a type and contents of data communicated by the cryptographic communication between the server and the client.

In accordance with the 23rd aspect of the present invention, the firewall sends to the server a request for a filter condition to restrict a type and contents of data communicated by the cryptographic communication between the server and the client. Therefore, the firewall can monitor and control the contents of the communication without altering the existing cryptographic communication protocol.

In accordance with a 24th aspect of the present invention, in the program product stored in the recording medium of the 22nd aspect, the firewall sends a request to the server to send therefrom entire communication data communicated by the cryptographic communication between the server and the client.

In accordance with the 24th aspect of the present invention, the firewall sends a request to the server to send therefrom entire communication data communicated by the cryptographic communication between the server and the client. As a result, the firewall can monitor and control the contents of the communication without altering the existing cryptographic communication protocol.

In accordance with the present invention, the cryptographic communication is achieved after a session to monitor the cryptographic communication is established between a server and a firewall, and hence the firewall is able to monitor and to control the contents of communication without altering an existing cryptographic communication protocol.

### BRIEF DESCRIPTION OF THE DRAWINGS

The objects and features of the present invention will become more apparent from the consideration of the following detailed description taken in conjunction with the accompanying drawings in which:

FIG. 1 is a sequence chart showing operation of the communication system of the conventional art;

FIG. 2 is a block diagram schematically showing an embodiment of a communication system in accordance with the present invention;

FIG. 3 is a sequence chart to explain operation of the communication system shown in FIG. 2; and

FIG. 4 is a conceptual diagram of a communication system serving as a premise of the present invention.

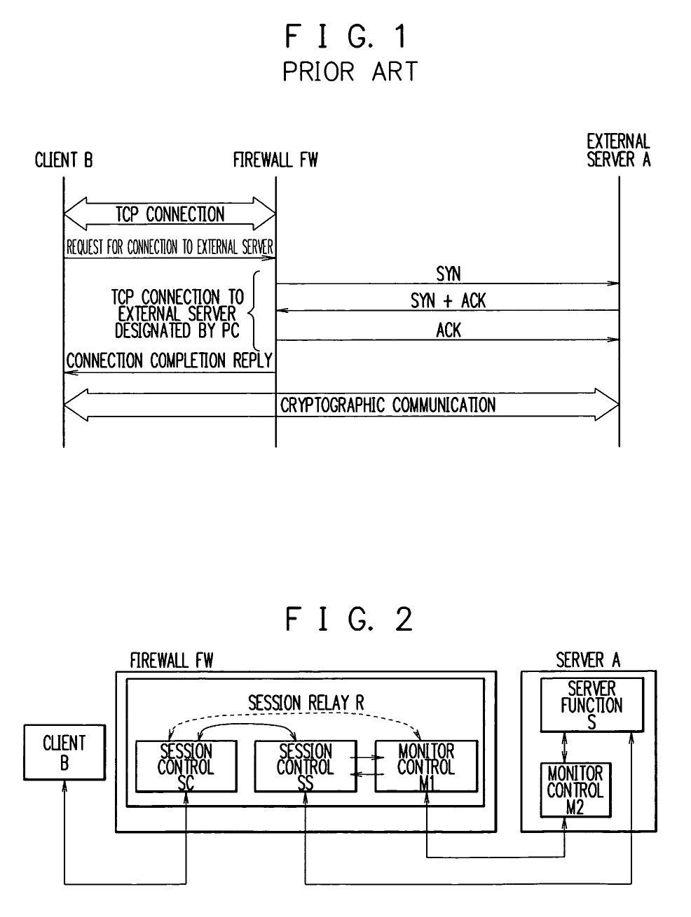

### DESCRIPTION OF THE EMBODIMENTS

Aspects of the Present Invention

In an encryption communication between a client and a server employing an existing firewall, only the firewall is allowed to intercept the contents of communication and/or the firewall notifies a communication condition.

Configuration

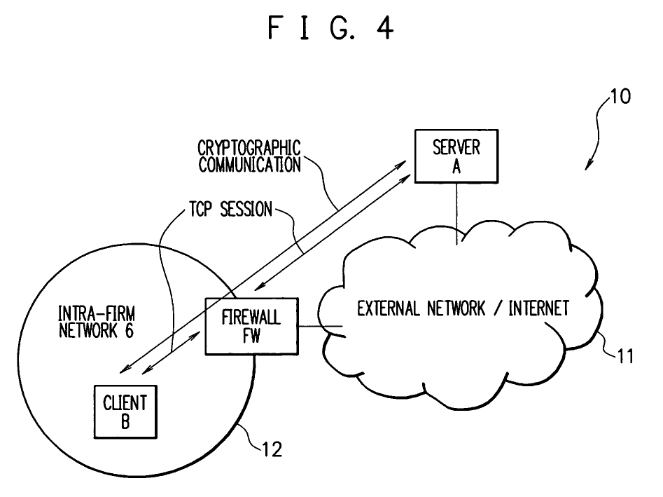

FIG. 4 is a conceptual diagram of a communication system serving as a premise of the present invention.

In FIG. 4, the communication system 10 includes a server A on an external network (or the Internet) 11, a firewall FW to link an intra-firm network 12 with the external network 11, and a personal computer B of a client of the intra-firm network 12 (hereinafter referred to as a client).

To conduct cryptographic communication between the server A and the client B, the client B establishes a TCP session to the firewall FW and then requests the firewall FW to set up connection to the server A. When the firewall FW completes the connection to the server A, the server A and the client B start procedures for the cryptographic communication.

A function shown in FIG. 2 is added to the server A and the firewall FW of this system.

FIG. 2 shows in a block diagram a configuration of a communication system of this embodiment.

A session relay unit R relays a session between the server A and the client B operates in the firewall FW.

The session relay unit R includes a session controller SC for controlling a TCP session between the client B and the firewall FW, and a session controller SS for controlling a TCP session between the server A and the firewall FW. The firewall FW further includes a monitor controller M1. The monitor controller M1 may control the session controller SC.

The server A includes a server function S. The server function S indicates, for example, a web server function. The server A further includes a monitor controller M2.

Operation

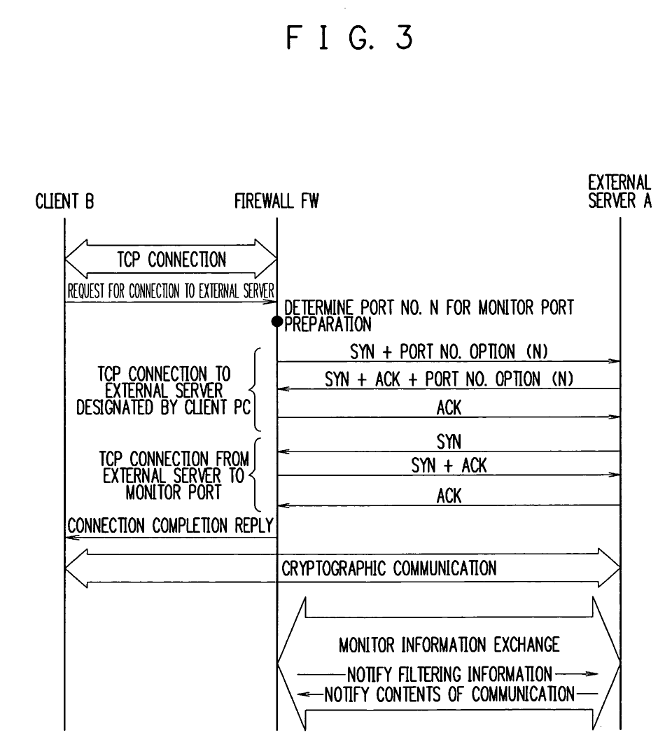

FIG. 3 shows operation of the communication system of FIG. 2 in a sequence chart.

According to the chart, in response to a request from the server B, a TCP connection process is executed to establish connection between the server B and the firewall FW.

The client B sends to the firewall FW a request for establishing connection to the server A.

The firewall FW prepares a port number N for a monitoring operation before establishing the TCP connection between the server A and the firewall FW.

Upon the TCP connection between the server A and the firewall FW, the firewall FW uses an SYN packet option and notifies the server A of the port number N.

The port number option is newly introduced in the present invention and consists of an m-octet type and an n-octet port number value, where m and n are natural numbers but n and m are independent of each other. Favorably, n=1 and m=2, namely, the port number consists of a one-octet type and a two-octet port number value.

Having received the port number notification, the server A sends the port number N to the firewall FW using an SYN+ACK packet option.

To complete the TCP connection process, the firewall FW delivers an ACK packet to the server A.

The server A then executes the TCP connection process for the port number N.

The firewall FW notifies the client B that the connection to the server A has been completely set up.

The cryptographic communication starts between the server A and the client B.

The firewall FW exchanges monitor information with the server A by use of a monitor port.

The firewall FW may be configured to send a request for a filter condition to the server A to restrict the type and the contents of the data exchanged between the server A and the client B through the cryptographic communication.

It is also possible to configure the firewall FW to send the server A a request that the serve A should send thereto all communication data items exchanged between the server A and the client B through the cryptographic communication.

The embodiment is only a favorable embodiment in accordance with the present invention and can be changed in various manners within the scope and spirit of the present invention.

When a recording medium has recorded a program including the procedures to implement, for example, the system described in the embodiment, by making a Central Processing Unit (CPU) in a computer execute the program obtained from the medium, it is possible to achieve the respective functions of the embodiment.

The present invention is also applicable irrespective of whether the recording medium is used or a group of information items including the program is supplied from an external recording medium via a network to an output device.

That is, a program code read from the recording medium implements the novel function of the present invention. The recording medium having recorded the program code and the signals obtained from the recording medium are also included in the scope of the present invention.

As the recording medium, there may be employed, for example, a flexible disk, a hard disk, an optical disk, a magnetooptical disk, a flash memory, a Compact Disk Read Only Memory (CD-ROM), a CD-R, a magnetic tape, a nonvolatile memory card, an ROM, or an Electrically Erasable Programmable (EEP) ROM (EEPROM).

By using the program, the respective functions of the embodiment of the present invention can be achieved in a communication system under the control of the program.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A communication method of conducting cryptographic communication between a client and a server via a firewall, comprising the step of:
establishing a session to monitor the cryptographic communication between the server and the firewall; and
conducting the cryptographic communication.

2. A communication method of conducting cryptographic communication between a client and a server via a firewall, comprising the steps of:
allowing by the server only the firewall to intercept contents of the communication;
notifying by the firewall a communication condition to the server; and
conducting the cryptographic communication.

3. A communication method of conducting cryptographic communication between a client and a server via a firewall, comprising the steps of:
establishing Transmission Control Protocol (TCP) connection between the client and the firewall;
conducting the cryptographic communication between the client and the server; and
exchanging monitor information between the firewall and the server.

4. A communication method of conducting cryptographic communication between a client and a server via a firewall, comprising the steps of:
executing a TCP connection process between the client and the firewall in response to a request from the client;
transmitting by the client a connection request to the firewall;
preparing by the firewall a port number N for a monitoring operation before TCP connection is established between the server and the firewall;
notifying by the firewall the port number N to the server using a synchronizing (SYN) packet option upon connection between the server and the firewall;
sending by the server to the firewall in response to reception of notification of the port number a reply including the port number N using an (SYN+ACK) option;
transmitting by the firewall an acknowledgement (ACK) packet as completion of the TCP connection process to the server;
executing by the server the TCP connection process for the port number N notified from the firewall;
notifying the client, by the firewall, of completion of connection to the server;
starting the cryptographic communication between the server and the client; and
exchanging by the firewall monitor information with the server using the port for the monitoring operation.

5. A communication method in accordance with claim 4, wherein the firewall sends to the server a request for a filter condition to restrict a type and contents of data communicated by the cryptographic communication between the server and the client.

6. A communication method in accordance with claim 4, wherein the firewall sends a request to the server to send entire communication data exchanged between the server and the client by the cryptographic communication.

7. A communication system comprising a client, a server, and a firewall for conducting cryptographic communication between the client and the server via the firewall, wherein after establishing a session to monitor the cryptographic communication between the server and the firewall, the cryptographic communication is conducted.

8. A communication system comprising a client, a server, and a firewall for conducting cryptographic communication between the client and the server via the firewall, wherein the server allows only the firewall to intercept contents of the communication, the firewall notifies a communication condition to the server, and the cryptographic communication is conducted thereafter.

9. A communication system comprising a client, a server, and a firewall for conducting cryptographic communication between the client and the server via the firewall, wherein the client and the firewall establish TCP connection therebetween, the client and the server conduct the cryptographic communication therebetween, and the firewall and the server exchange monitor information therebetween.

10. A communication system comprising a client, a server, and a firewall for conducting cryptographic communication between the client and the server via the firewall, wherein:
the client issues a request for TCP connection processing between the client and the firewall and transmits a connection request to the firewall;
the firewall prepares a port number N for a monitoring operation before TCP connection is established between the server and the firewall and notifies the port number N to the server using an SYN packet option upon connection between the server and the firewall;
the server sends to the firewall in response to reception of notification of the port number a reply including the port number N using an (SYN+ACK) option;
the firewall transmits an ACK packet as completion of the TCP connection process to the server;
the server executes the TCP connection process for the port number N notified from the firewall;
the firewall notifies the client of completion of connection to the server; and
the firewall exchanges, when the server and the client start the cryptographic communication therebetween, monitor information with the server using the port for the monitoring operation.

11. A communication system in accordance with claim 10, wherein the firewall sends to the server a request for a filter condition to restrict a type and contents of data exchanged between the server and the client by the cryptographic communication.

12. A communication system in accordance with claim 10, wherein the firewall sends a request to the server to send therefrom entire communication data exchanged between the server and the client by the cryptographic communication.

13. A program product for making a substantial computer of the server achieve control of cryptographic communication between a client and a server via a firewall, the program product making the computer execute processing to conduct the cryptographic communication after establishing a session to monitor the cryptographic communication between the server and the firewall.

14. A program product for making a substantial computer of the server achieve control of cryptographic communication between a client and a server via a firewall, the program product making the computer execute processing in which:
the server allows only the firewall to intercept contents of the communication;
the firewall notifies a communication condition to the server; and
the cryptographic communication is conducted thereafter.

15. A program product for making a substantial computer of the server achieve control of cryptographic communication between a client and a server via a firewall, the program product making the computer execute processing in which:
the client and the firewall establish TCP connection therebetween;
the client and the server conduct the cryptographic communication therebetween; and
the firewall and the server exchange monitor information therebetween.

16. A program product for making a substantial computer of the server achieve control of cryptographic communication between a client and a server via a firewall, the program product making the computer execute processing in which:
TCP connection processing is executed between the client and the firewall in response to a request from the client;
the client transmits a connection request to the firewall;
the firewall prepares a port number N for a monitoring operation before TCP connection is established between the server;
the firewall notifies the port number N to the server using an SYN packet option at connection between the server and the firewall;
the server sends to the firewall in response to reception of notification of the port number a reply including the port number N using an (SYN+ACK) option;
the firewall transmits an ACK packet as completion of the TCP connection processing to the server;
the server executes the TCP connection processing for the port number N notified from the firewall;
the firewall notifies the client of completion of connection to the server;
the server and the client start the cryptographic communication therebetween; and
the firewall exchanges monitor information with the server using the port for the monitoring operation.

17. The program product in accordance with claim 16, the program product making the computer execute processing in which:
the firewall sends to the server a request for a filter condition to restrict a type and contents of data exchanged between the server and the client by the cryptographic communication.

18. The program product in accordance with claim 16, the program product making the computer execute processing in which:
the firewall sends a request to the server to send therefrom entire communication data exchanged between the server and the client by the cryptographic communication.

19. A recording medium having recorded a program product for making a substantial computer of the server achieve control of cryptographic communication between a client and a server via a firewall, the program product making the computer execute processing to conduct the cryptographic communication after establishing a session to monitor the cryptographic communication between the server and the firewall.

20. A recording medium having recorded a program product for making a substantial computer of the server achieve control of cryptographic communication between a client and a server via a firewall, the program product making the computer execute processing in which:
the server allows only the firewall to intercept contents of the communication;
the firewall notifies a communication condition to the server; and
the cryptographic communication is conducted thereafter.

21. A recording medium having recorded a program product for making a substantial computer of the server achieve control of cryptographic communication between a client and a server via a firewall, the program product making the computer execute processing in which:
the client and the firewall establish TCP connection therebetween;
the client and the server conduct the cryptographic communication therebetween; and
the firewall and the server exchange monitor information therebetween.

22. A recording medium having recorded a program product for making a substantial computer of the server achieve control of cryptographic communication between a client and a server via a firewall, the program product making the computer execute processing in which:
TCP connection processing is executed between the client and the firewall in response to a request from the client;
the client transmits a connection request to the firewall;
the firewall prepares a port number N for a monitoring operation before TCP connection is established between the server;
the firewall notifies the port number N to the server using an SYN packet option at connection between the server and the firewall;
the server sends to the firewall in response to reception of notification of the port number a reply including the port number N using an (SYN+ACK) option;
the firewall transmits an ACK packet as completion of the TCP connection processing to the server;
the server executes the TCP connection processing for the port number N notified from the firewall;
the firewall notifies the client of completion of connection to the server;
the server and the client start the cryptographic communication therebetween; and
the firewall exchanges monitor information with the server using the port for the monitoring operation.

23. The recording medium in accordance with claim 22, the program product making the computer execute processing in which:
the firewall sends to the server a request for a filter condition to restrict a type and contents of data exchanged between the server and the client by the cryptographic communication.

24. The recording medium in accordance with claim 22, wherein the firewall sends a request to the server to send therefrom entire communication data exchanged between the server and the client by the cryptographic communication.
